(19) United States
(12) Patent Application Publication
(10) Pub. No.: US 2003/0231275 A1
(43) Pub. Date: Dec. 18, 2003

(54) Liquid crystal display device

(76) Inventors: Yasuyuki Shirato, Fukushima-shi (JP); Akihiko Ohta, Fukushima-shi (JP)

Correspondence Address: Otto O. Lee, Intellectual Property Law Group LLP, Suite 1205, 12 South First St., San Jose, CA, 95113, US

(21) Appl. No.: 10/461,253

(22) Filed: Jun. 12, 2003

(30) Foreign Application Priority Data
Jun. 13, 2002 (JP) 2002-172724

(51) Int. Cl. G02F 1/1345

(52) U.S. Cl. 349/149

(57) ABSTRACT

An embodiment of the invention comprises transparent electrodes 2 and an LSI input/output electrical conductive lines 4, directly formed on one substrate 10 of transparent substrates 9 and 10, an LSI 5 is mounted on the substrate 10, and thereon a FPC assembly 14 composed of FPC 8 mounted with electric components 13 and a connector 17 provided on the FPC 8 is attached, whereby a liquid crystal display device in which, after the LSI is mounted, the mounted condition (an electrically connected condition) and lighting of an image display portion can be visually confirmed, is provided. Since the transparent electrical conductive line electrode 2 and the LSI input/output electrical conductive line 4 are covered by the FPC 8, electrolytic corrosion of the transparent electrical conductive line electrode 2 and the LSI input/output electrical conductive line 4 made of ITO, etc., due to moisture can be prevented, and disconnection due to electrolytic corrosion of the transparent electrical conductive line electrodes 2 and the LSI input/output electrical conductive lines 4 can be prevented.

### BACKGROUND OF THE INVENTION

1. Technical Field

The present invention relates to a liquid crystal display device.

2. Background Art

Previously, COG (Chip on Glass) modules and COG stick modules have been known as liquid crystal display devices.

FIG. 13 shows a perspective view of a COG stick module, and hereinafter, a method for fabricating a COG stick module as shown in FIG. 13 will be described.

As shown in FIG. 1, electrical conductive lines of a transparent electrical conductive line electrodes 2 are formed on a transparent substrate 3 by photolithography, and on the obtained transparent substrate 3 with transparent electrodes 2, LSI input/output electrical conductive lines 4 are formed to obtain a COG stick substrate 1, and moreover, on this COG stick substrate 1, an LSI 5 is mounted by an ACF (Anisotropic Conductive Film) method as shown in FIG. 2, whereby a circuit board portion (a COG stick) 6 is fabricated. Then, FPC (Flexible Printed Circuits) 7 for connection to a liquid crystal display element 11 is connected to an output terminal of the LSI 5 of the circuit board portion 6.

In addition, a liquid crystal display portion 11, as shown in FIG. 13, in which a front glass substrate 9 with transparent pixel electrodes (unillustrated) and a rear glass substrate 10 with transparent counter pixel electrodes (unillustrated) are overlapped with each other so that both electrodes are arranged in an opposed manner and liquid crystals are sealed in respective pixel regions between the front glass substrate 9 and rear glass substrate 10, respectively, is fabricated in advance, its electrode terminals and the FPC 7 are connected, whereby a liquid crystal display device 15 is obtained.

Moreover, it is desirable to arrange a sheet polarizer on the front surface of the front surface 9, and a flexible cable 8 for a connection to a power-source side is connected to the input electrical conductive lines 4 on the side opposite to the output electrical conductive lines 4 on the LSI 5 side of the circuit board 6.

As the transparent substrate 3 of the circuit board portion 6, a transparent glass substrate is used, and furthermore, transparent electrical conductive line electrodes 2 are formed on this glass substrate, whereby after the LSI 5 is mounted by an ACF method on the circuit board portion 6, it becomes possible to inspect, from the transparent substrate 3 surface on the side opposite to the LSI 5a attaching portion, through a microscope or the like, a connection state between the LSI 5 and transparent electrical conductive line electrode 2 visually or by use of an image recognition device.

For the above-described front and rear transparent substrates 9 and 10, a transparent resin and transparent glass are used, however, since glass is used in most cases, the region where the LSI 5 is connected exists on a glass substrate, and therefore, a liquid crystal display device composed of the above-described liquid crystal display portion 11 and circuit board portion 6 is sometimes referred to as a Chip on Glass (COG) stick module.

In addition, FIG. 14 shows a configuration view according to a prior art in a case where electric components 13 and a connector 17 are set in the above-described COG stick module, wherein the liquid crystal display portion 11 is attached on a backlight 23, and the electric components 13 and connector 17 are also attached on a printed circuit board 24 with a COG stick module attached, separately from the COG stick module.

No electric components other than the LSI 5 can be mounted on the COG stick substrate 1 of the prior-art COG stick module as shown in FIG. 13 or FIG. 14. This is because an ITO transparent electrode was used for electrical conductive lines on the COG stick substrate 1, and no soldering components including capacitors, resistors, a ZIF connector could be mounted.

In addition, when electric components such as power-stabilizing capacitors and step-up capacitors are mounted on the printed circuit board 24, terminals for a connection of said electric components including capacitors are required, and therefore, a large number of input pins are required on the transparent substrate 3.

### SUMMARY OF THE INVENTION

It is an object of the present invention to provide a liquid crystal display device, of which the final outside dimensions is reduced as much as possible, which is often determined depending on the printed circuit substrate 24 shown in FIG. 14.

In addition, it is an object of the present invention to provide a liquid crystal display device in which an LSI can be mounted in a reduced space and in which, after the LSI is mounted, the mounted condition (an electrically connected condition) and lighting of an image display portion can be visually confirmed.

The above-described objects of the present invention are achieved by the following construction.

According to an embodiment of the invention, a liquid crystal display device comprises: a liquid crystal display portion in which a first substrate with transparent pixel electrodes and a second substrate with transparent counter pixel electrodes are overlapped with each other so that both electrodes are arranged in an opposed manner and liquid crystals are sealed in pixel regions between the first substrate and second substrate; a circuit board portion in which, on the surface of a hard substrate with electrical conductive lines connected to the transparent pixel electrodes of the liquid crystal display portion, an integrated circuit chip to control conduction of the electrical conductive line is mounted; and a first flexible connecting means which unites either first or second substrate of the liquid crystal display portion and the hard substrate of the circuit board portion into one substrate, covers a region of the circuit board portion including an electrical conductive line installing region other than an integrated circuit chip mounting part, and is loaded with electric components electrically connected to the integrated circuit chip.

According to another embodiment of the invention, in the liquid crystal display device, the liquid crystal display portion and the circuit substrate portion are separate, and the transparent pixel electrodes of the liquid crystal display portion and the electrical conductive lines of the circuit substrate portion are electrically connected via a second soft connecting means.

According to another embodiment of the invention, in the liquid crystal display device, the first substrate and the second substrate of said liquid crystal display portion, and the hard substrate of said circuit substrate portion are transparent substrates.

According to another embodiment of the invention, in the liquid crystal display, the transparent substrates are glass substrates.

According to another embodiment of the invention, in the liquid crystal display device, the glass substrates are the same kind of glass and the same thickness.

### BRIEF DESCRIPTION OF THE DRAWINGS

FIG. 1 is a perspective view of a COG stick substrate on which LSI input/output electrical conductive lines have been formed, according to an embodiment of the present invention.

FIG. 2 is a perspective view showing a circuit board portion (a COG stick) obtained by mounting an LSI on the COG stick substrate of FIG. 1.

FIG. 3 is a perspective view showing an FPC assembly in which electric components including condensers, resistors, and a connector have been mounted on FPC, according to an embodiment of the present invention.

FIG. 4 is a perspective view showing a COG stick assembly in which the FPC assembly of FIG. 3 has been connected to the circuit board portion (COG stick) of FIG. 2.

FIG. 5 is a perspective view of a liquid crystal display device according to an embodiment of the present invention.

FIG. 6 is a partial view of a section along the A-A line of FIG. 5.

FIG. 7 is a perspective view of a liquid crystal display device according to an embodiment of the present invention.

FIG. 8 is a perspective view showing an FPC assembly in which electric components including condensers, resistors, and a connector have been mounted on FPC, according to an embodiment of the present invention.

FIG. 9 is a perspective view of a liquid crystal display device according to an embodiment of the present invention.

FIG. 10 is a perspective view of a liquid crystal display device according to an embodiment of the present invention.

FIG. 11 is a perspective view of a liquid crystal display device according to an embodiment of the present invention.

FIG. 12 is a plan view showing a main part of the liquid crystal display device according to an embodiment of the present invention shown in FIG. 10.

FIG. 13 is a perspective view of a liquid crystal display device according to a prior art.

FIG. 14 is a perspective view of a liquid crystal display device according to a prior art.

### DETAILED DESCRIPTION OF SPECIFIC EMBODIMENTS

Embodiments of the present invention will be described with reference to the drawings.

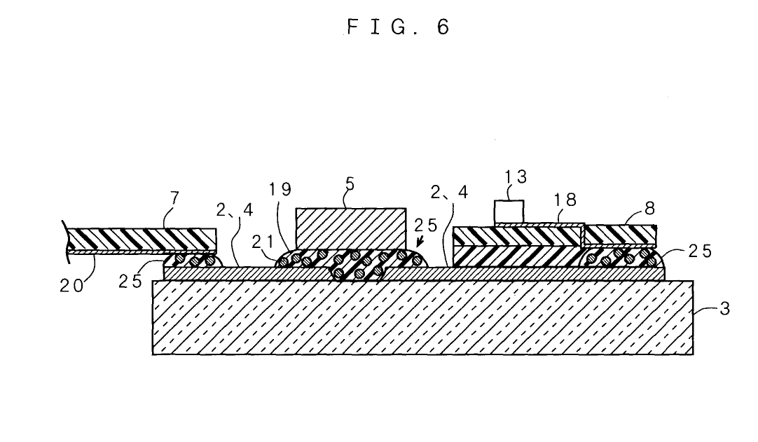

In the present embodiment, as shown in the perspective view of FIG. 5, electric components including capacitors, resistors, and a connector are mounted on a flexible connecting means such as a bilayered (or multilayered) FPC. By connecting the above-described flexible connecting means mounted with electric components, such as FPC, to a COG stick, a component mounted area is reduced compared to that of a prior-art article, therefore, a liquid crystal display device which occupies a reduced space and allows simple assembly can be provided.

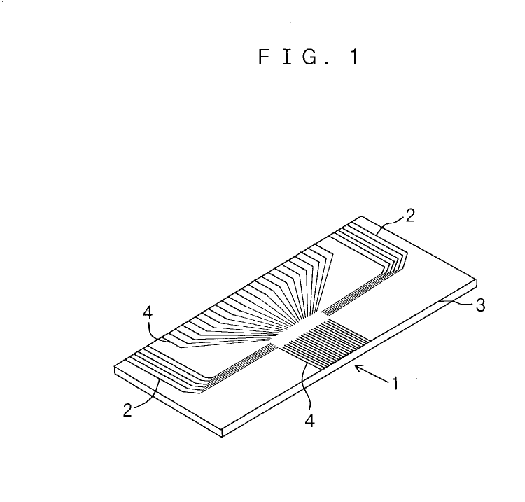

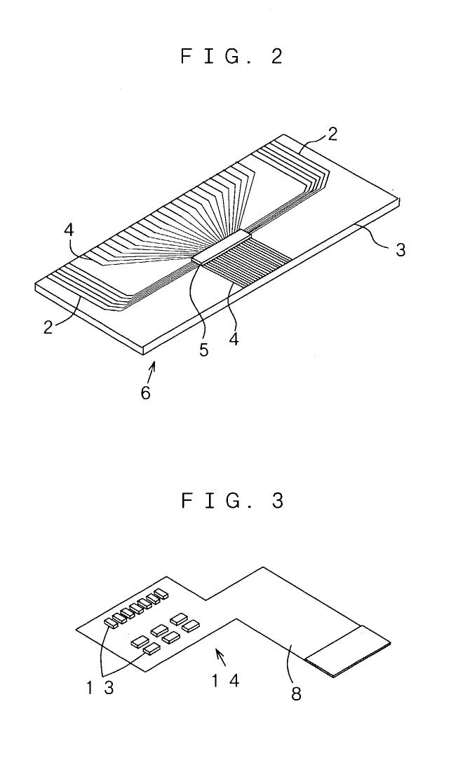

Hereinafter, a method for fabricating a liquid crystal display device according to the present embodiment will be described with reference to the drawings. As shown in FIG. 1, electrical conductive lines of a transparent electrical conductive line electrodes 2 and LSI input/output electrical conductive line 4 are formed on a hardened substrate 3 (not necessarily transparent) such as a glass plate by photolithography to obtain a COG stick substrate 1 as shown in FIG. 1, and on this COG stick substrate 1, an LSI 5 is mounted by an ACF method, whereby a circuit board portion (a COG stick) 6 is fabricated (FIG. 2).

Next, as shown in FIG. 3, a bilayered (or multilayered) FPC (Flexible Printed Circuits) 8 is fabricated, and on this FPC 8, electric components 13 including capacitors, resistors, and a connector are mounted so as to provide an FPC assembly 14 (FIG. 3). The FPC 8 is of such outside dimensions as not to protrude from the external form of the COG stick substrate 1 and not to overlap the LSI 5, which is mounted on the COG stick substrate 1.

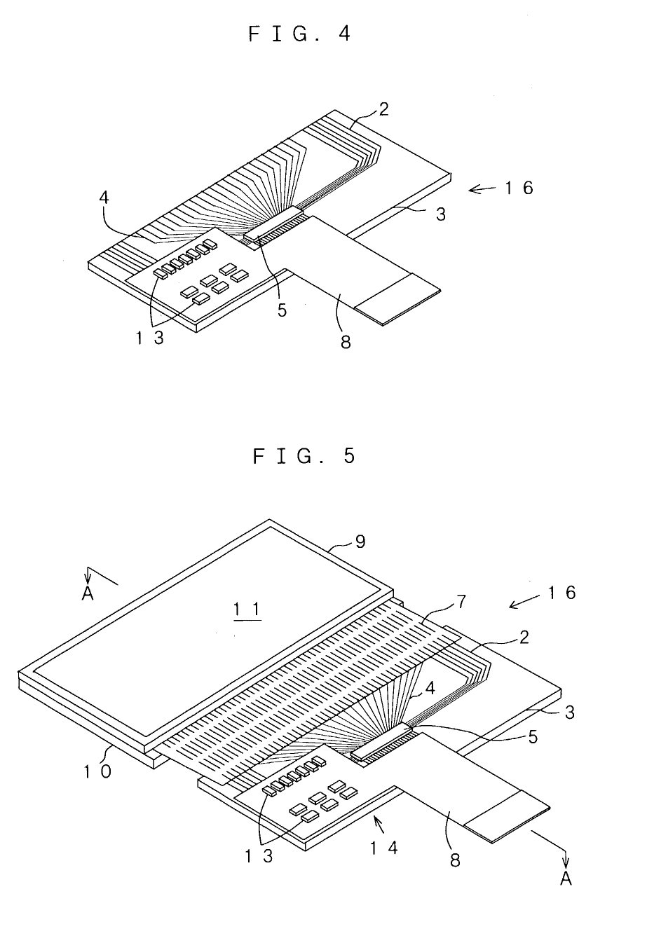

The FPC assembly 14 of FIG. 3 is connected to the COG stick 6 as shown in FIG. 2 by a widely-known method via an ACF or the like, whereby a COG stick assembly 16 as shown in FIG. 4 is fabricated.

By connecting the COG stick assembly 16 and a crystal display element 11 by the FPC 7 as a flexible cable, a liquid crystal display device as shown in FIG. 5 can be obtained.

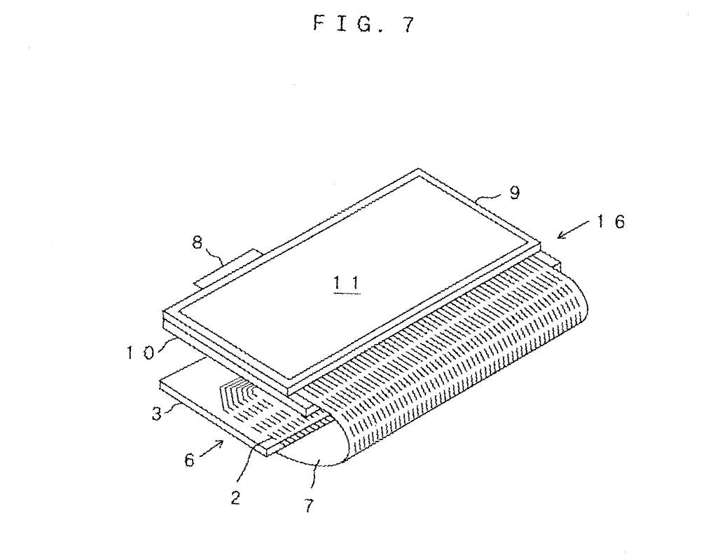

FIG. 6 shows a main part of a section along the A-A line of FIG. 5, wherein electrical conductive lines such as a transparent electrical conductive line electrodes 2 made of ITO and electrical conductive lines 4 made of ITO exists on a substrate 3, and on the substrate 3, via an anisotropic conductive film (ACF) 25 which is formed by plating the front surfaces of particles 21 with gold and embedding the same in a resin 19, an LSI 5 is connected to the transparent electrical conductive line electrodes 2 and the LSI input/output electrical conductive lines 4. Moreover, electric components 13 including capacitors and resistors are arranged on FPC 8. These electric components 13 are connected to the above-described transparent electrical conductive line electrodes 2 and LSI input/output electrical conductive lines 4 via electrical conductive line 18 (copper electrical conductive line formed by etching) and an external power-supply unit of the anisotropic conductive film (ACF), etc. The FPC 8 is connected to the substrate 3 via the ACF 25. In addition, electrical conductive lines 20 (copper electrical conductive line formed by etching) of the FPC 7 for connecting electrically to the liquid crystal display element 11 are also connected to the ITO transparent electrical conductive line electrodes 2 and the LSI input/output electrical conductive lines 4 via the ACF 25.

In the liquid crystal device 15 shown in FIG. 5, the FPC 7, which connects the circuit board portion 6 and the liquid crystal display element 11, can be bent, therefore, if the circuit board portion 6 as a mounting portion of the LSI 5 and the liquid crystal display portion 11 are overlapped with each other with the front glass substrate 9 having the liquid crystal display portion 11 exposed outside as shown in FIG. 7, a compact liquid crystal display device 15 can be obtained.

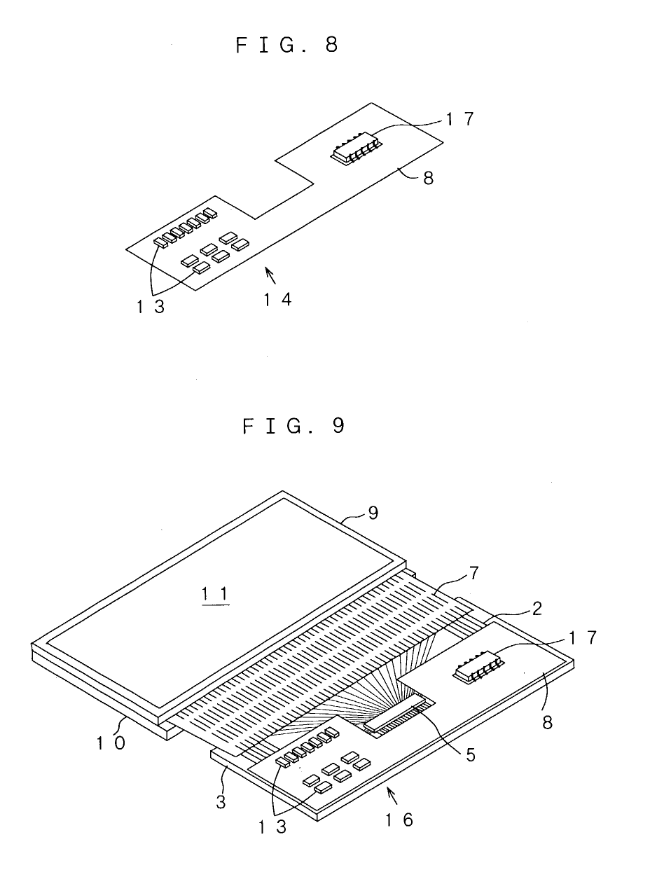

The FPC 7, which connects the COG stick assembly 16 and the liquid crystal display element 11, can be bent, therefore, if a board-to-board connector 17 is attached to the FPC stick assembly 14 in advance, which is formed by loading electric components 13 and connectors on the FPC 7 as shown in FIG. 8, the FPC stick assembly 14 can be attached to an external power-supply unit or the like through one-touch operation (FIG. 8 and FIG. 9). A heat seal, a flexible flat cable (FFC), an anisotropic conductive rubber connector or the like may be used in place of the FPCs 7 and 8.

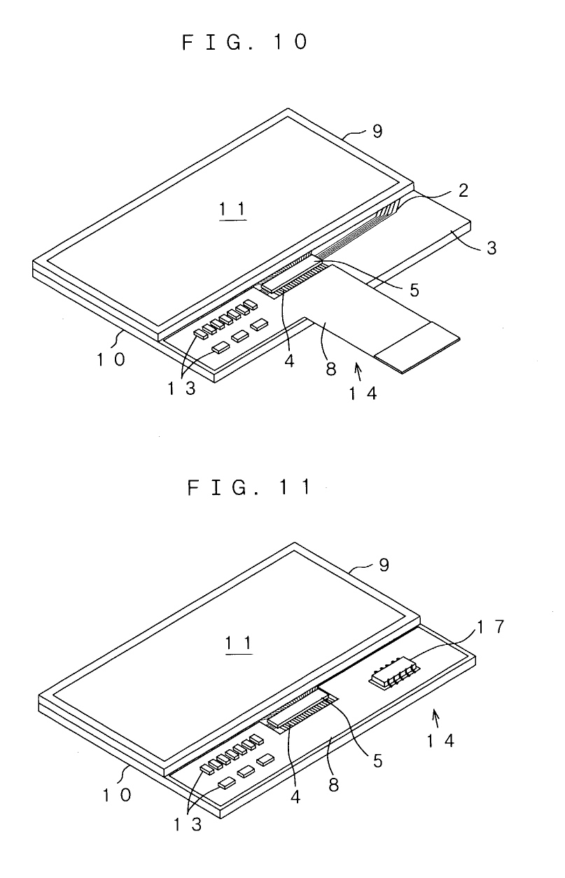

Although the FPC assembly 14 as shown in FIG. 3 has been connected to the COG stick 6 as shown FIG. 2 in the above-described embodiment, it may be possible to, as shown in FIG. 10 and FIG. 11, directly form ITO transparent electrodes 2 and LSI input/output electrical conductive lines 4 on one substrate 10 of transparent substrates 9 and 10, further mount an LSI 5 on the substrate 10, and attach, thereon, a FPC assembly 14 composed of FPC 8 mounted with electric components 13 and a connector 17, so as to form a liquid crystal display device. FIG. 10 shows a case where no connector 17 is attached, while FIG. 11 shows a case where a connector 17 is provided.

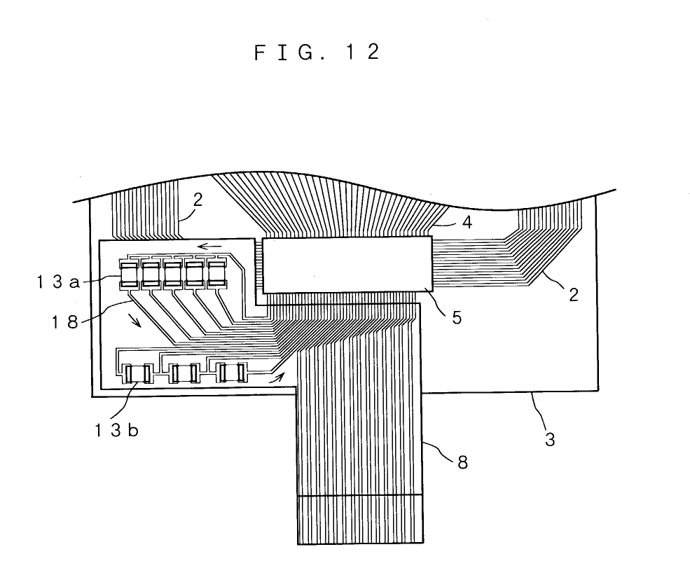

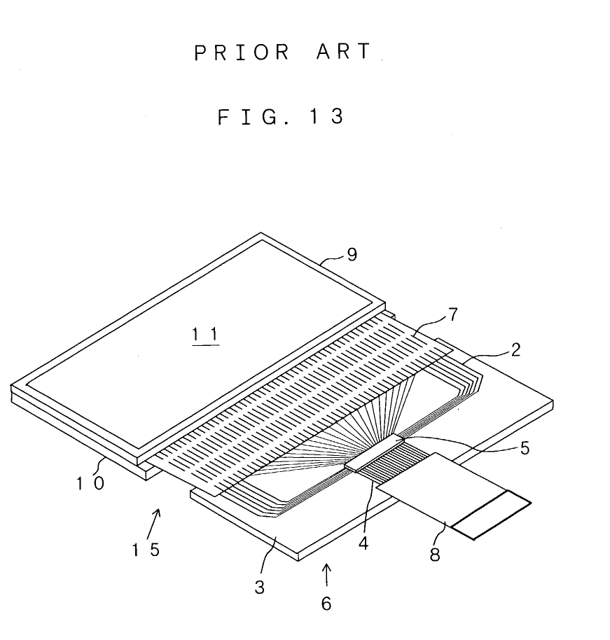

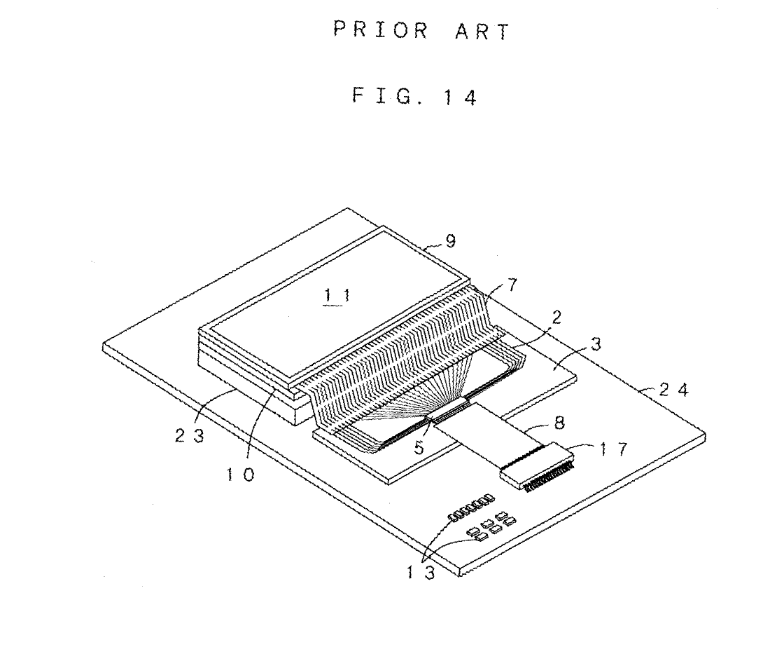

FIG. 12 shows an enlarged plan view of an FPC assembly 14 installing part of FIG. 10. The electric components 13 (capacitors 13a and resistors 13b) and connector 17 are connected by metal (copper) electrodes on the surface of the flexible connecting means 8 or in through holes.

As is clearly understood by a comparison between the constructions of the liquid crystal display devices of FIG. 9 through FIG. 11 and the construction of the prior-art liquid crystal display device as shown in FIG. 14, the installing space of the electronic components 13 and connector 17, etc., is compact in the cases of the present embodiment.

Although the substrate 3 is not necessarily transparent, by providing this substrate 3 as a transparent plate such as glass, an advantage is provided such that a connected condition between the FPCs 7 and 8 and LSI 5 and the transparent electrical conductive line electrodes 2 and LSI input/output electrical conductive lines 4 can be easily confirmed.

The adhesion between the transparent electrical conductive electrodes 2 and the substrate 3 can be improved in comparison with the adhesion between the transparent electrical conductive electrode 2 and an organic resin board such as an epoxy resin board and a polyester resin board.

As a result, there is an advantage that the reliability of the liquid crystal display device 11 of this invention in the environment of high temperature and high humidity can be especially raised.

In addition, there is merit on the production process that those substrates 3 can be obtained from one original glass plate at the same time by the cutting separation of the glass plate, because the substrates 3 have the same chemical composition and thickness as substrates 9 and substrates 10.

In this case, the merit is caused that transparent pixel electrodes of liquid crystal display portion (a liquid crystal display element 11) and transparent electrical conductive lines of circuit substrate portion 6 can be processed at the same time (the coating of the transparent conductive film and the patterning processing can be manufactured at the same process).

The simplification of these processes becomes practicable merit from an industrial production viewpoint in economically manufacturing the liquid crystal display devices of this invention.

The glass such as soda lime silicate, alumino silicate, alumino borosilicate, non alkali silicate can be used as the glass which can be used for the glass substrate.

In addition, by covering the transparent electrical conductive line electrodes 2 and the LSI input/output electrical conductive line 4 with the FPCs 7 and 8, electrolytic corrosion of the transparent electrical conductive line electrode 2 and LSI input/output electrical conductive line 4 made of ITO, etc., due to moisture can be prevented, whereby disconnection due to electrolytic corrosion of the transparent electrical conductive line electrodes 2 and the LSI input/output electrical conductive lines 4 can be prevented.

In addition, as is clearly understood by a comparison between FIG. 14 showing a prior art and FIG. 5 and FIG. 9 through FIG. 11 showing the present embodiment, the liquid crystal display device according to the present invention has a great space-saving effect.

In addition, in the present embodiment, since the electric components 13 including capacitors and resistors to be connected to the LSI 5 are mounted on the flexible connecting means 8, there exists an advantage such that the number of input terminals can be greatly reduced compared to that of the prior art. As a description thereof based on the example of FIG. 12, one input terminal is used in common among five capacitors 13a, and the capacitors 13a are provided with five output terminals and form a closed circuit with the LSI 5. In addition, one input terminal is provided in common among three resistors 13b, and the resistors 13b form a closed circuit in which output terminals from the respective resistors 13b are lead out to the LSI 5. Namely, if input and output terminals were respectively provided for the five capacitors 13a and three resistors 13b, 16 lines of electrical conductive line would be required, while 10 lines are sufficient in the construction as shown in FIG. 12, therein exists an advantage.

Industrial Applicability

According to an embodiment of the invention, since the first flexible connecting means (FPC 8), which covers a region of the circuit board portion (substrate portion 6) including electrical conductive lines installing region other than the integrated circuit chip (LSI 5) mounting part and is loaded with electric components electrically connected to the integrated circuit chip, is provided and the electrical conductive lines (transparent electrical conductive line electrode 2 and LSI input/output electrical conductive lines 4) of the circuit board portion are covered by the first flexible connecting means, the electrical conductive lines, which are made of ITO, etc., are prevented from corroding due to moisture, whereby disconnection due to electrolytic corrosion of the electrical conductive lines are eliminated.

Moreover, according to an embodiment of the invention, since the electric components are loaded on the circuit substrate portion, a compact construction can be provided as a whole, whereby a great space-saving effect is provided.

Moreover, according to an embodiment of the invention, since electric components including capacitors and resistors are loaded on the circuit substrate portion, the integrated circuit chip (LSI 5) and the electric components can form closed circuits, whereby the number of input terminals of the electric components can be greatly reduced compared to that of the prior art, therein exists an advantage.

Moreover, according to an embodiment of the invention, in addition to the effects of the first aspect of the invention, the liquid crystal display portion and the circuit board portion can be overlapped with each other by bending the first flexible connecting means (FPC 7), whereby a liquid crystal display portion which occupies a reduced space as a whole can be obtained.

Moreover, according to an embodiment of the invention, since the hard substrate (hard substrate 3) is transparent, an advantage is provided such that a connected condition between the first and second flexible connecting means (FPC 8 and FPC 7) and integrated circuit chip (LSI 5) and the electrical conductive line (transparent electrical conductive line electrode 2 and LSI input/output electrical conductive line 4) of the circuit board portion (substrate 3) can be easily confirmed.

Moreover, according to an embodiment of the invention, the adhesion between the transparent electrical conductive electrodes 2 and the substrate 3 can be improved in compared with the adhesion between the transparent electrical conductive electrode 2 and a synthetic resin board, and the reliability of this invention in the environment of high temperature and high humidity can be raised.

Moreover, according to an embodiment of the invention, there is a merit on the production process that those substrates 3 can be obtained from one original glass plate at the same time by the cutting separation of the glass plate, because substrates 3 have the same chemical composition and thickness as substrates 9 and substrates 10.

What is claimed is:

1. A liquid crystal display device comprising:
a liquid crystal display portion in which a first substrate with transparent pixel electrodes and a second substrate with transparent counter pixel electrodes are overlapped with each other so that said both electrodes are arranged in an opposed manner and liquid crystals are sealed in pixel regions between said first substrate and second substrate;
a circuit board portion in which, on the surface of a hard substrate with electrical conductive lines connected to the transparent pixel electrodes of said liquid crystal display portion, an integrated circuit chip to control conduction of said electrical conductive line is mounted;
and a first flexible connecting means which unites either first or second substrate of said liquid crystal display portion and the hard substrate of said circuit board portion into one substrate, covers a region of said circuit board portion including an electrical conductive line installing region other than an integrated circuit chip mounting part, and is loaded with electric components electrically connected to said integrated circuit chip.

2. The liquid crystal display device according to claim 1, wherein
said liquid crystal display portion and said circuit substrate portion are separate, and the transparent pixel electrodes of said liquid crystal display portion and the electrical conductive lines of said circuit substrate portion are electrically connected via a second soft connecting means.

3. The liquid crystal display device according to claim 1 or 2, wherein the first substrate and the second substrate of said liquid crystal display portion, and the hard substrate of said circuit substrate portion are transparent substrates.

4. The liquid crystal display device according to claim 3, wherein the transparent substrates are glass substrates.

5. The liquid crystal display device according to claim 4, wherein the glass substrates are the same kind of glass and the same thickness.
